(19) United States
(12) Patent Application Publication
(10) Pub. No.: US 2014/0197233 A1
(43) Pub. Date: Jul. 17, 2014

(54) VIDEO PICTURE MAIL VERIFICATION

(71) Applicant: Jehoshaphat Huguley, Atlanta, GA (US)

(72) Inventor: Jehoshaphat Huguley, Atlanta, GA (US)

(21) Appl. No.: 14/155,049

(22) Filed: Jan. 14, 2014

Related U.S. Application Data
(60) Provisional application No. 61/752,037, filed on Jan. 14, 2013.

(51) Int. Cl. G06Q 10/08; G06K 19/06

(52) U.S. Cl. CPC G06Q 10/083; G06K 19/06037
USPC 235/375; 235/494

(57) ABSTRACT

A video picture mail verification system for delivering and receiving mail. Implementations of the present invention can take a picture or create a video of a sender of a piece of mail (i.e., package) and generate a unique code for that mail. In some implementations, a picture or video of the content of the mail is also taken. The picture and unique code may be stored on a server. The unique code may be printed and placed on the mail and delivered as normal. The recipient of the mail can retrieve the picture(s) or video from the server using the unique code on the package prior to opening the mail. In some implementations, the mail may not be delivered until an acknowledgement is sent to the mailer.

### CROSS REFERENCE TO RELATED APPLICATION

This application claims the benefit of Patent Application Ser. No. 61/752,037, which was filed on Jan. 14, 2013, and is incorporated herein by reference in its entirety

### TECHNICAL FIELD

This disclosure relates to mail delivery service and more particularly to securely receiving mail.

### BACKGROUND

Mail is a major gateway to infiltrate a residential, business, or government entity. Sophisticated and expensive equipment and complex internal procedures exist to address mail threats. However, these solutions do not provide a deterrent to placing mail intended to harm in the delivery system in the first instant.

U.S. Patent Application Publ. No. 2003/0079137 (“'137 application”) discloses a system and method for identifying who sent a piece of mail or a parcel. The system relies on collecting identifying information (e.g., fingerprints, photo, and/or retinal scan) from the sender and electronically storing it. The collected identifying information then is attached through a variety of methods (e.g., micro-dots, micro-writing, ink bar coding) to the mail or parcel to be dispatched. The '137 patent teaches that the collected identifying information may be checked against a law enforcement data base.

However, the system disclosed in the '137 application has several disadvantages. First, the collected identifying information for the parcel cannot be remotely accessed by the recipient prior to receiving the parcel. Second, once the parcel is received, the collected identifying information associated with parcel cannot be accessed without special decoding equipment. Third, the system only is concerned with security and not with attaching other useful or entertaining information to parcel.

### BRIEF DESCRIPTION OF THE DRAWINGS

FIG. 1 illustrates an example video picture mail verification (VPMV) system in accordance with the present invention.

FIG. 2 illustrates an example environment of the present disclosure for implementations of the video picture mail verification system.

FIG. 3 illustrates another example environment of the present disclosure for implementations of the video picture mail verification system.

FIG. 4 illustrates an example computer system that may be used with some implementations of the present invention

FIG. 5 illustrates an example label that may be placed on package in accordance with the present invention.

### DETAILED DESCRIPTION

Implementations of a video picture mail verification (VPMV) system are provided. In some implementations, the VPMV of the present invention may take a picture or create a video of a sender of a piece of mail (, package) and generate a unique code for that mail. In some implementations, a picture or video of the content of the mail is also taken. The picture and unique code may be stored on a server. The unique code may be printed and placed on the mail and delivered as normal. The recipient of the mail can retrieve the picture(s) or video from the server using the unique code on the package prior to opening the mail. In some implementations, the mail may not be delivered until an acknowledgement is sent to the mailer.

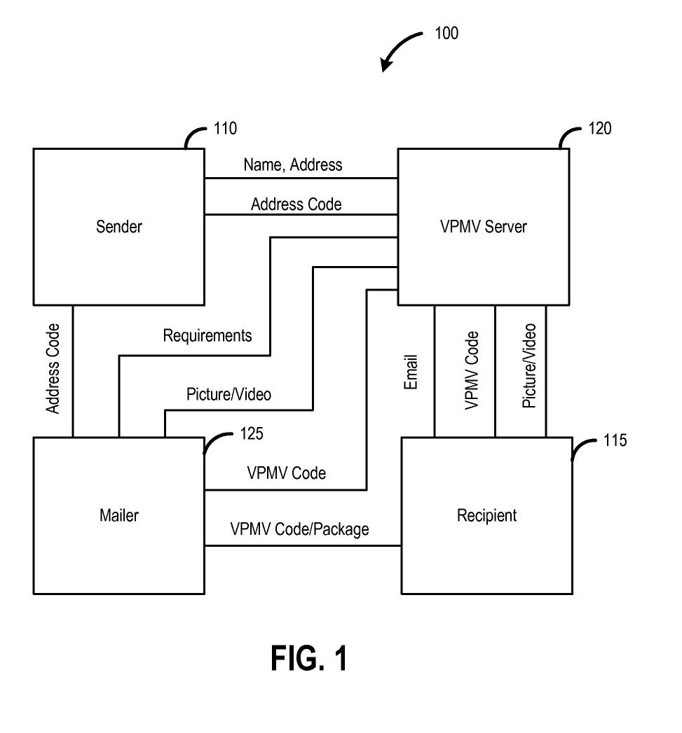

FIG. 1 illustrates an example video picture mail verification (VPMV) system 100. First, in some implementations, a sender 110 desiring to mail a package to a recipient 115 via the VPMV system 100 can retrieve an address code for a pre-registered recipient from the VPMV server 120. In some implementations, the sender 110 can retrieve the address code by providing the name and/or address of the recipient to the VPMV server 120. The sender 110 then may provide the address code to a mailer 125 (e.g., USPS, FedEX, UPS, or any other shipper, courier, or deliver of mail, packages, or any other thing that is delivered from one place to another). In some implementations, the sender 110 can bypass the address code steps.

In some implementations, using an address code, the mailer 125 can retrieve from the VPMV server 120 the recipient's requirement for the delivery of mail. In some implementations, the mailer 120 receives the address code from the sender or retrieves the address code by providing the name and/or address of the recipient to the VPMV server 120.

In some implementations, the recipient 115 can require that the sender 110 provide a picture of the sender 110, a picture of the content of the package, or any other picture or video requirement (e.g., a video of the sender saying his name) prior to acceptance of the mail. The mailer 125 may then take the requisite pictures and/or videos which may then be stored on the VPMV server 120.

In some implementations, the recipient 115 can specify that it will pay for the postage. In such a case, the mailer 125 can retrieve the payment from the recipient's 115 account. In some implementations, the recipient 115 may receive an email informing the recipient 115 that its account was debited to pay for postage.

The VPMV server 120 can generate and provide to the mailer 125 a VPMV code for the package to be delivered. The pictures and/or videos taken for the package can be associated with the VPMV code generated.

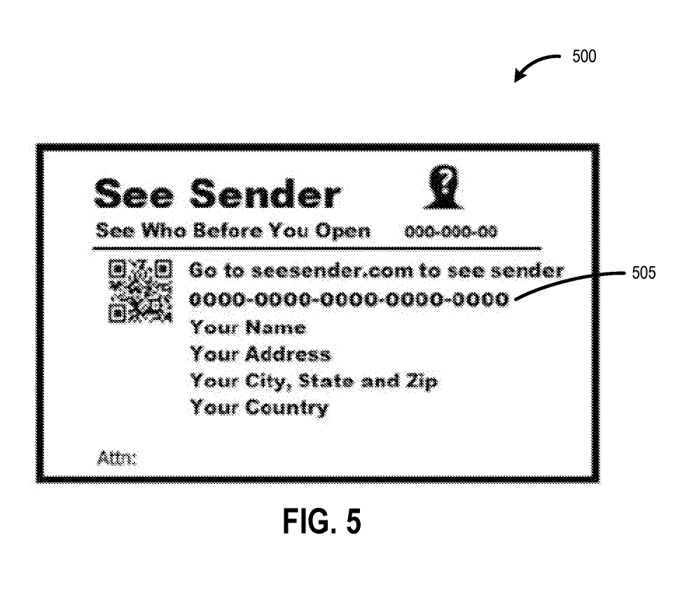

The mailer 125 can then print and label the package with the VPMV code and deliver the package as usual. FIG. 5 illustrates an example label 500 having a VPMV code 505 that may be placed on a package. In some implementations, the recipient 115 may receive an email that includes the VPMV code for the package to be delivered.

Once the recipient 115 receives the email with the VPMV code or receives the package with the VPMV code 505 on the package, the recipient 115 can retrieve the picture(s) or video from the VPMV server 120 using the VPMV code. In some implementations, where the mail is not delivered until acknowledgement is received, the recipient 115 can send an acceptance or rejection of the mail to the mailer 125.

In some implementations, the picture and/or video requirement associated with a VPMV code may be retrieved using a smart phone equipped to read the VPMV code. In this way, the recipient 115 may review the picture and/or video associated with the VPMV code without manually accessing the VPMV server 120 and manually entering the VPMV code. In some implementations, the VPMV code may be a matrix barcode (e.g., QR code®). In some implementations, the picture and/or video associated with a VPMV code may be retrieved using a smart phone equipped with a matrix barcode scanner (e.g., a QR-code scanner).

For those recipients 115 that are not pre-registered, the VPMV server 120 can still generate and provide to the mailer 125 a VPMV code for a package to be delivered. The mailer 125 may then take default pictures and/or videos which may then be stored on the VPMV server 120 in association with the VPMV code generated. The mailer 125 can then print and label the package with the VPMV code and deliver the package as usual along with instructions on how to use the VPMV system. In some implementations, the recipient 115 pays a fee to retrieve the picture(s) or video from the VPMV server using the VPMV code.

In some implementations, the VPMV system 100 can be used for social purposes such as to deliver a birthday, anniversary, or other special occasion video message or picture in conjunction with the delivery of flowers, a card, or other present or package.

In some implementations, the VPMV system 100 can be used for advertisement purposes. For example, a business can include a picture of video advertisement message to a package.

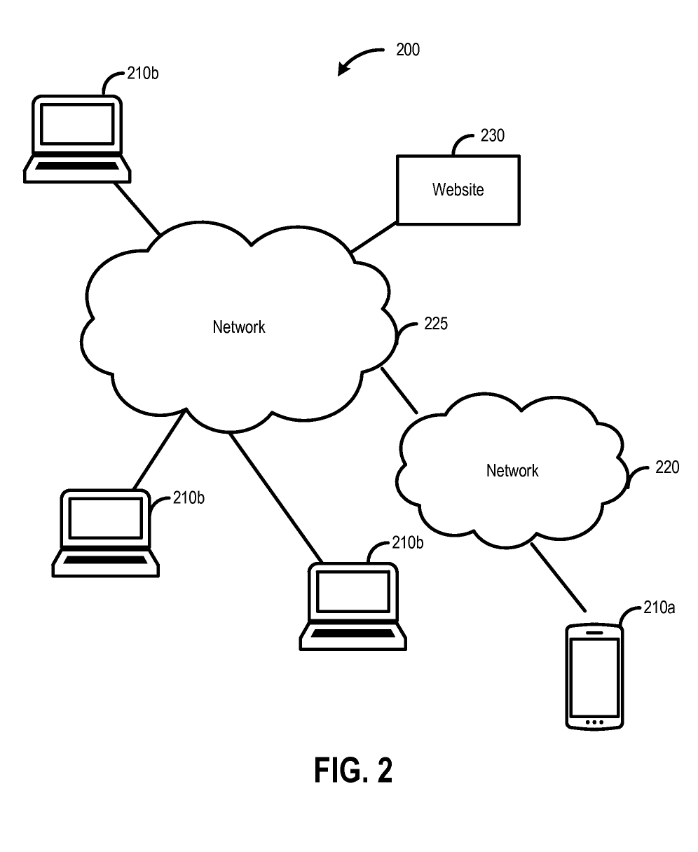

FIG. 2 illustrates an example environment 200 for delivering mail using a video picture mail verification system 100 according to the present disclosure.

As shown in FIG. 2, the environment 200 can include client devices 210a and 210b (collectively client device 210), a wireless cellular network 220, a network 225, a website 230 and retailer devices 215. In some implementations, the website 230 may be communicatively connected with a VPMV server 120. In some implementations, the website 230 may be hosted on a VPMV server 120. Client devices 210a and 210b are depicted as a mobile phone 210a and desktop computer 210b, respectively, but client devices 210 may comprise any type of computing device, such as a desktop computer system, a laptop, a smartphone, a mobile telephone, a tablet-style computer, or any other handheld electronic device.

In some implementations, the client device 210a can connect to the network 225 through a wireless cellular network 220, such as GPRS-based and CDMA-based wireless networks, as well as 802.16 WiMax and long-range wireless data networks.

Client devices 210a and 210b can interact with the website 230 via an application, such as a web browser or a native application, residing on the client devices 210a and 210b to access the VPMV server 120. In some implementations, a client device 210 may be used to access the VPMV server 120 by a sender 110, a mailer 125 and/or a recipient 115.

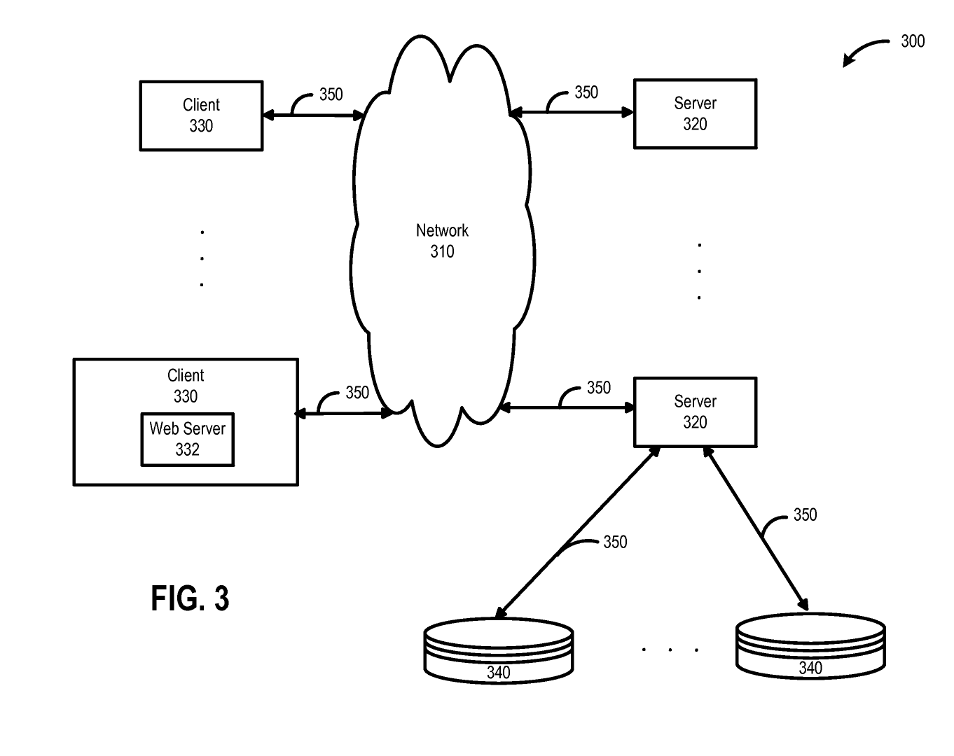

FIG. 3 illustrates another example environment 300 of the present disclosure for delivering mail using a video picture mail verification system 100. The example environment 300 can include a network 310, one or more servers 320, and one or more clients 330. The example environment 300 also can include one or more data storage 340 linked to one or more servers 320. Particular embodiments may be implemented in network environment 300. For example, applications used to render the user interfaces to perform the functions described above may be written in software programs hosted by one or more servers 320.

In some implementations, network 310 may be an intranet, an extranet, a virtual private network (VPN), a local area network (LAN), a wireless LAN (WLAN), a wide area network (WAN), a metropolitan area network (MAN), a portion of the Internet, or another network 310 or a combination of two or more such networks 310. The present disclosure contemplates any suitable network 310.

One or more links 350 couple a server 320 or a client 330 to network 310. In some implementations, one or more links 350 each can include one or more wired, wireless, or optical links 350. In some implementations, one or more links 350 each can include an intranet, an extranet, a VPN, a LAN, a WLAN, a WAN, a MAN, a portion of the Internet, or another link 350 or a combination of two or more such links 350. The present disclosure contemplates any suitable links 350 coupling servers 320 and clients 330 to network 310.

In some implementations, each server 320 may be a unitary server or may be a distributed server spanning multiple computers or multiple datacenters. Servers 320 may be of various types, such as, for example and without limitation, web server, file server, application server, exchange server, database server, or proxy server. In some implementations, each server 320 may include hardware, software, or embedded logic components or a combination of two or more such components for carrying out the appropriate functionalities implemented or supported by server 320. For example, a web server is generally capable of hosting websites containing web pages or particular elements of web pages. More specifically, a web server may host HTML files or other file types, or may dynamically create or constitute files upon a request, and communicate them to clients 330 in response to HTTP or other requests from clients 330. A database server is generally capable of providing an interface for managing data stored in one or more data stores.

In some implementations, one or more data storages 340 may be communicatively linked to one or more servers 320 via one or more links 350. In some implementations, data storages 340 may be used to store various types of information. In some implementations, the information stored in data storages 340 may be organized according to specific data structures. In particular embodiment, each data storage 340 may be a relational database. Particular embodiments may provide interfaces that enable servers 320 or clients 330 to manage, , retrieve, modify, add, or delete, the information stored in data storage 340.

In some implementations, each client 330 may be an electronic device including hardware, software, or embedded logic components or a combination of two or more such components and capable of carrying out the appropriate functions implemented or supported by client 330. For example and without limitation, a client 330 may be any type of computing device such as a desktop computer system, a laptop, a smartphone, a mobile telephone, a tablet-style computer, or any other handheld electronic device. The present disclosure contemplates any suitable clients 330. A client 330 may enable a network user at client 330 to access network 330. A client 330 may enable its user to communicate with other users at other clients 330.

A client 330 may have a web browser 332, such as MICROSOFT INTERNET EXPLORER, GOOGLE CHROME, MOZILLA FIREFOX, or any other future developed web browser and may have one or more add-ons, plug-ins, or other extensions. A user at client 330 may enter a Uniform Resource Locator (URL) or other address directing the web browser 332 to a server 320, and the web browser 332 may generate a Hyper Text Transfer Protocol (HTTP) request and communicate the HTTP request to server 320. Server 320 may accept the HTTP request and communicate to client 230 one or more Hyper Text Markup Language (HTML) files responsive to the HTTP request. Client 330 may render a web page based on the HTML files from server 320 for presentation to the user. The present disclosure contemplates any suitable web page files. As an example and not by way of limitation, web pages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a web page encompasses one or more corresponding web page files (which a browser may use to render the web page) and vice versa, where appropriate.

In some implementations, a client 330 having a web browser 332 can connect to a server 320 to use the video picture mail verification 100 system. In some implementations, input received from a recipient 115, a sender 110, and/or a mailer 125 may be stored in a data storage 340 communicatively linked to the servers 320. For example, a picture of the sender 110, a picture of the content of a package, or any other picture or video (e.g., a video of the sender saying his name) may be stored in a data storage 340 communicatively linked to the servers 320. In some implementations, the data storage 340 may be a database.

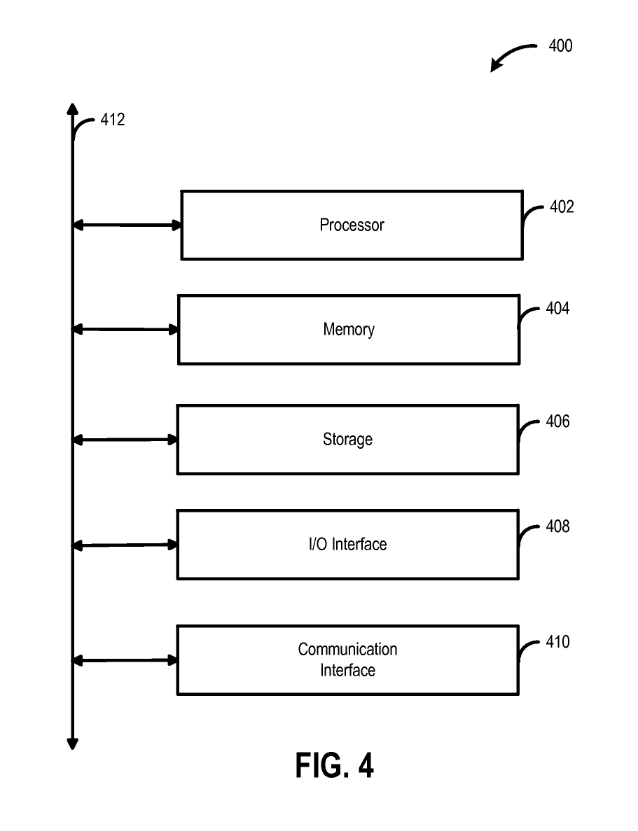

FIG. 4 illustrates an example computer system 400, which may be used with some embodiments of the present invention. This disclosure contemplates any suitable number of computer systems 400. This disclosure contemplates computer system 400 taking any suitable physical form. As example and not by way of limitation, computer system 400 may be an embedded computer system, a system-on-chip (SOC), a single-board computer system (SBC) (such as, for example, a computer-on-module (COM) or system-on-module (SOM)), a desktop computer system, a laptop, an interactive kiosk, a mainframe, a mesh of computer systems, a mobile telephone, a personal digital assistant (PDA), a server, or a combination of two or more of these. Where appropriate, computer system 400 may include one or more computer systems 400; be unitary or distributed; span multiple locations; span multiple machines; or reside in a cloud, which may include one or more cloud components in one or more networks. Where appropriate, one or more computer systems 400 may perform without substantial spatial or temporal limitation one or more steps of one or more methods described or illustrated herein. As an example and not by way of limitation, one or more computer systems 400 may perform in real time or in batch mode one or more steps of one or more methods described or illustrated herein. One or more computer systems 400 may perform at different times or at different locations one or more steps of one or more methods described or illustrated herein, where appropriate.

In some implementations, computer system 400 includes a processor 402, memory 404, storage 406, an input/output (I/O) interface 408, a communication interface 410, and a bus 412. Although this disclosure describes and illustrates a particular computer system having a particular number of particular components in a particular arrangement, this disclosure contemplates any suitable computer system having any suitable number of any suitable components in any suitable arrangement.

In some implementations, processor 402 includes hardware for executing instructions, such as those making up a computer program. As an example and not by way of limitation, to execute instructions, processor 402 may retrieve (or fetch) the instructions from an internal register, an internal cache, memory 404, or storage 406; decode and execute them; and then write one or more results to an internal register, an internal cache, memory 404, or storage 406. In some implementations, processor 402 may include one or more internal caches for data, instructions, or addresses. The present disclosure contemplates processor 402 including any suitable number of any suitable internal caches, where appropriate. As an example and not by way of limitation, processor 402 may include one or more instruction caches, one or more data caches, and one or more translation look-aside buffers (TLBs). Instructions in the instruction caches may be copies of instructions in memory 404 or storage 406, and the instruction caches may speed up retrieval of those instructions by processor 402. Data in the data caches may be copies of data in memory 404 or storage 406 for instructions executing at processor 402 to operate on; the results of previous instructions executed at processor 402 for access by subsequent instructions executing at processor 402 or for writing to memory 404 or storage 406; or other suitable data. The data caches may speed up read or write operations by processor 402. The TLBs may speed up virtual-address translation for processor 402. In some implementations, processor 402 may include one or more internal registers for data, instructions, or addresses. The present disclosure contemplates processor 402 including any suitable number of any suitable internal registers, where appropriate. Where appropriate, processor 402 may include one or more arithmetic logic units (ALUs); be a multi-core processor; or include one or more processors 402. Although this disclosure describes and illustrates a particular processor, this disclosure contemplates any suitable processor.

In some implementations, memory 404 includes main memory for storing instructions for processor 402 to execute or data for processor 402 to operate on. As an example and not by way of limitation, computer system 400 may load instructions from storage 406 or another source (such as, for example, another computer system 400) to memory 404. Processor 402 may then load the instructions from memory 404 to an internal register or internal cache. To execute the instructions, processor 402 may retrieve the instructions from the internal register or internal cache and decode them. During or after execution of the instructions, processor 402 may write one or more results (which may be intermediate or final results) to the internal register or internal cache. Processor 402 may then write one or more of those results to memory 404. In some implementations, processor 402 executes only instructions in one or more internal registers or internal caches or in memory 404 (as opposed to storage 406 or elsewhere) and operates only on data in one or more internal registers or internal caches or in memory 404 (as opposed to storage 406 or elsewhere). One or more memory buses (which may each include an address bus and a data bus) may couple processor 402 to memory 404. Bus 412 may include one or more memory buses, as described below. In some implementations, one or more memory management units (MMUs) reside between processor 402 and memory 404 and facilitate accesses to memory 404 requested by processor 402. In some implementations, memory 404 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. The present disclosure contemplates any suitable RAM. Memory 404 may include one or more memories 402, where appropriate. Although this disclosure describes and illustrates particular memory, this disclosure contemplates any suitable memory.

In some implementations, storage 406 includes mass storage for data or instructions. As an example and not by way of limitation, storage 406 may include an HDD, a floppy disk drive, flash memory, an optical disc, a magneto-optical disc, magnetic tape, or a Universal Serial Bus (USB) drive or a combination of two or more of these. Storage 406 may include removable or non-removable (or fixed) media, where appropriate. Storage 406 may be internal or external to computer system 400, where appropriate. In some implementations, storage 406 is non-volatile, solid-state memory. In some implementations, storage 406 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 406 taking any suitable physical form. Storage 406 may include one or more storage control units facilitating communication between processor 402 and storage 406, where appropriate. Where appropriate, storage 406 may include one or more storages 406. Although this disclosure describes and illustrates particular storage, this disclosure contemplates any suitable storage.

In some implementations, I/O interface 408 includes hardware, software, or both providing one or more interfaces for communication between computer system 400 and one or more I/O devices. Computer system 400 may include one or more of these I/O devices, where appropriate. One or more of these I/O devices may enable communication between a person and computer system 400. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 408 for them. Where appropriate, I/O interface 408 may include one or more device or software drivers enabling processor 402 to drive one or more of these I/O devices. I/O interface 408 may include one or more I/O interfaces 408, where appropriate. Although this disclosure describes and illustrates a particular I/O interface, this disclosure contemplates any suitable I/O interface.

In some implementations, communication interface 410 includes hardware, software, or both providing one or more interfaces for communication (such as, for example, packet-based communication) between computer system 400 and one or more other computer systems 400 or one or more networks. As an example and not by way of limitation, communication interface 410 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 410 for it. As an example and not by way of limitation, computer system 400 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 400 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 400 may include any suitable communication interface 410 for any of these networks, where appropriate. Communication interface 410 may include one or more communication interfaces 410, where appropriate. Although this disclosure describes and illustrates a particular communication interface, this disclosure contemplates any suitable communication interface.

In some implementations, bus 412 includes hardware, software, or both coupling components of computer system 400 to each other. As an example and not by way of limitation, bus 412 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCI-X) bus, a serial advanced technology attachment (SATA) bus, a Video Electronics Standards Association local (VLB) bus, or another suitable bus or a combination of two or more of these. Bus 412 may include one or more buses 412, where appropriate. Although this disclosure describes and illustrates a particular bus, this disclosure contemplates any suitable bus or interconnect.

Herein, reference to a computer-readable storage medium encompasses one or more non-transitory, tangible computer-readable storage media possessing structure. As an example and not by way of limitation, a computer-readable storage medium may include a semiconductor-based or other integrated circuit (IC) (such, as for example, a field-programmable gate array (FPGA) or an application-specific IC (ASIC)), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. Herein, reference to a computer-readable storage medium excludes any medium that is not eligible for patent protection under 35 C. §101. Herein, reference to a computer-readable storage medium excludes transitory forms of signal transmission (such as a propagating electrical or electromagnetic signal per se) to the extent that they are not eligible for patent protection under 35 C. §101.

This disclosure contemplates one or more computer-readable storage media implementing any suitable storage. In some implementations, a computer-readable storage medium implements one or more portions of processor 602 (such as, for example, one or more internal registers or caches), one or more portions of memory 604, one or more portions of storage 606, or a combination of these, where appropriate. In some implementations, a computer-readable storage medium implements RAM or ROM. In some implementations, a computer-readable storage medium implements volatile or persistent memory. In some implementations, one or more computer-readable storage media embody software. Herein, reference to software may encompass one or more applications, bytecode, one or more computer programs, one or more executables, one or more instructions, logic, machine code, one or more scripts, or source code, and vice versa, where appropriate. In some implementations, software includes one or more application programming interfaces (APIs). This disclosure contemplates any suitable software written or otherwise expressed in any suitable programming language or combination of programming languages. In some implementations, software is expressed as source code or object code. In some implementations, software is expressed in a higher-level programming language, such as, for example, C, Perl, or a suitable extension thereof. In some implementations, software is expressed in a lower-level programming language, such as assembly language (or machine code). In some implementations, software is expressed in JAVA. In some implementations, software is expressed in Hyper Text Markup Language (HTML), Extensible Markup Language (XML), or other suitable markup language.

The present disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure. For example. it will apparent to one of ordinary skill in the art that the invention may be used with any electronic network service, even if it is not provided through a website. Any computer-based system that provides networking functionality can be used in accordance with the present invention even if it relies, for example, on e-mail, instant messaging or other forms of peer-to-peer communications, and any other technique for communicating between users. The invention is thus not limited to any particular type of communication system, network, protocol, format or application.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

While the foregoing processes and mechanisms can be implemented by a wide variety of physical systems and in a wide variety of network and computing environments, the server or computing systems described below provide example computing system architectures for didactic, rather than limiting, purposes.

The present invention has been explained with reference to specific embodiments. For example, while embodiments of the present invention have been described as operating in connection with a network system, the present invention can be used in connection with any communications facility that allows for communication of messages between users, such as an email hosting site. Other embodiments will be evident to those of ordinary skill in the art. It is therefore not intended that the present invention be limited, except as indicated by the appended claims.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

The present disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend.

1. A computer-implemented process for delivering mail, wherein a mailer may deliver a package to a recipient on behalf of a sender, the process comprising:
obtaining identifying information associated with a package to be delivered;
transmitting the identifying information to a server for storage;
receiving a package code for the identifying information; and
labeling a package to be mailed with the package code.

2. The process of claim 1 further comprising receiving recipient's delivery requirement wherein the recipient's delivery requirement includes identifying information.

3. The process of claim 2 further comprising transmitting an address code associated with a recipient to receive the recipient's delivery requirements.

4. The process of claim 1 further comprising delivering the package to the recipient.

5. The process of claim 3 further comprising receiving payment information associated with the address code and collecting payment for the delivery of the package.

6. The process of claim 1 wherein the identifying information is at least one picture.

7. The process of claim 5 wherein the at least one picture is a picture of the sender.

8. The process of claim 5 wherein the at least one picture is a picture of the package content.

9. The process of clam 1 wherein the identifying information is at least one video.

10. The process of claim 8 wherein the at least one video is a video of the sender.

11. The process of claim 5 wherein the at least one video is a video of the package content.

12. The process of clam 1 further comprising transmitting a personal message from the sender to a server for storage and wherein the package code is associated with the identifying information and the personal message.

13. The process of clam 1 wherein the package code is a matrix barcode.

14. A computer-implemented process for delivering mail, the process comprising:
receiving and storing identifying information associated with a package to be delivered; and
generating and transmitting a package code for the identifying information.

15. The process of claim 14 further comprising receiving the package code, retrieving the identifying information associated with the package code, and transmitting the identifying information.

16. The process of clam 14 wherein the package code is a matrix barcode.

17. The process of clam 14 further comprising transmitting an electronic notification containing the package code to a recipient.

18. A processor-based system, comprising:
computer readable storage medium having instructions, which, if executed by a processor, cause the processor-based system to receive and store identifying information associated with a package to be delivered and generate and transmit a package code for the identifying information.

19. The processor-based system of claim 18 further comprising instructions, which, if executed by a processor, cause the processor-based system to receive the package code, retrieve the identifying information associated with the package code, and transmit the identifying information.

20. The processor-based system of claim 18 further comprising instructions, which, if executed by a processor, cause the processor-based system to transmit an electronic notification containing the package code to a recipient.
